(19) United States
(12) Patent Application Publication
(10) Pub. No.: US 2006/0282643 A1
(43) Pub. Date: Dec. 14, 2006

(54) Transparent low-density mode for multi-level cell flash memory devices

(76) Inventors: Subramanyam Chandramouli, Folsom, CA (US); Gerard A. Kreifels, El Dorado Hills, CA (US); Bharat M. Pathak, Folsom, CA (US); Edward Babb, Rescue, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/150,504

(22) Filed: Jun. 10, 2005

(51) Int. Cl. G06F 12/00

(52) U.S. Cl. 711/203; 711/103

(57) ABSTRACT

In high-density mode, data may be stored in consecutive byte blocks. In low-density mode, a codeword of memory space may have the capacity to store two bytes of data, but may be used to store only a single byte of data. In a multi-level cell architecture where two or more bits may be stored in a single cell, memory address translation circuitry (or other system component) may translate data to be stored in low-density mode. Memory address translation circuitry may adjust the bit ordering of data to be stored to compensate for the consequences of low-density mode. A single flash memory device may have data stored in one portion in low-density mode and data stored in another portion in high-density mode. Error correcting code (ECC) may be applied in high-density mode and not in low-density mode.

### TECHNICAL FIELD

Embodiments of the invention relate to techniques for storing data in flash memory cells. More particularly, embodiments of the invention relate to techniques for storing data in flash memory cells in a lower-density mode in a manner that may be transparent to a programmer.

### BACKGROUND

Flash memory is an increasingly popular form of non-volatile storage that may be used with, for example, digital cameras or portable storage devices. Original flash memory devices stored a single bit per memory cell. More recently, multi-level cell flash devices have been developed that allow multiple bits to be stored in a single flash memory cell. Multi-level cells that store two bits per cell can approximately double the storage capacity of a single level cell memory configuration.

A multi-level flash cell includes two gates referred to as the control gate and the floating gate, which may be insulated by an oxide layer. The floating gate is positioned between the control gate and the substrate. Because the floating gate is isolated, electrons placed on the floating gate remain and store information. The electrons placed on the floating gate cancel an electric field from the control gate, which modifies the threshold voltage of the cell. When the cell is read by placing a specific voltage on the control gate, the amount of resulting current flow is sensed and determines the values stored in the cell.

A flash cell is programmed by causing electrons to flow from the cell transistor source to the transistor drain when a relatively high voltage is placed on the control gate to provide a strong enough electric field to cause electrons to flow to the floating gate. To erase a cell that stores two bits, the cell is reset to a value of 11 (binary), which corresponds to a relatively low level of electrons on the floating gate. Other values (10, 01 and 00, binary) are stored in the cell by placing additional electrons on the floating gate through an electron tunneling process. Thus, cells may be written to a lower value (11 to 01), but not to a higher value (01 to 10) without resetting the cell.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of an electronic system.

FIG. 2a is a conceptual illustration of a physical memory array in low-density mode corresponding to a logical memory having addressing holes.

FIG. 2b is a conceptual illustration of a logical memory array in low-density mode having addressing holes.

FIG. 3a is a conceptual illustration of a physical memory array in low-density mode corresponding to a logical memory not having addressing holes.

FIG. 3b is a conceptual illustration of a logical memory array in low-density mode not having addressing holes.

FIG. 4 is a flow diagram of one embodiment for writing a codeword of data to a flash memory device.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Described herein is a technique for storing data in a flash memory in a low-density mode and/or a high-density mode. In high-density mode, data may be stored in consecutive byte blocks. That is, each codeword of memory space may have capacity to store two bytes of data and may store two bytes of data in high-density mode. In low-density mode, a codeword of memory space may have the capacity to store two bytes of data, but may be used to store only a single byte of data. Other codeword sizes and/or data block sizes may also be used.

In a multi-level cell architecture where two or more bits may be stored in a single cell, the memory address translation circuitry (or other system component) may translate data to be stored in low-density mode. In one embodiment, each multi-level cell may be used to store a single bit of data rather than the multiple bits that the cell is capable of storing. This may logically result in logical memory addresses that are unused in low-density mode because only a portion of the storage capacity of each cell in an array of memory cells is used. This may result in memory addressing holes in low-density mode. As described in greater detail below, the memory address translation circuitry may adjust the bit ordering of data to be stored to compensate for the consequences of low-density mode.

In one embodiment, a single flash memory device may have data stored in one portion in low-density mode and data stored in another portion in high-density mode. In one embodiment error correcting code (ECC) is applied in high-density mode and not in low-density mode.

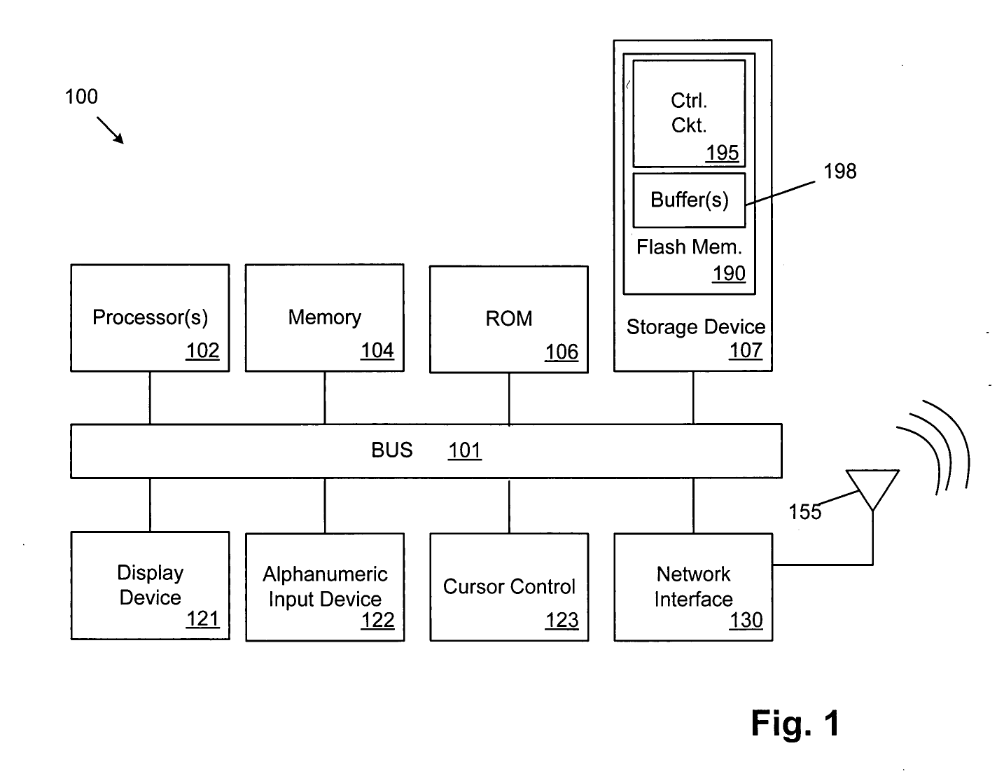

FIG. 1 is a block diagram of one embodiment of an electronic system. The electronic system illustrated in FIG. 1 is intended to represent a range of electronic systems including, for example, desktop computer systems, laptop computer systems, cellular telephones, personal digital assistants (PDAs) including cellular-enabled PDAs, set top boxes. Alternative computer systems can include more, fewer and/or different components.

Electronic system 100 includes bus 101 or other communication device to communicate information, and processor 102 coupled to bus 101 that may process information. While electronic system 100 is illustrated with a single processor, electronic system 100 may include multiple processors and/or co-processors. Electronic system 100 further may include random access memory (RAM) or other dynamic storage device 104 (referred to as main memory), coupled to bus 101 and may store information and instructions that may be executed by processor 102. Main memory 104 may also be used to store temporary variables or other intermediate information during execution of instructions by processor 102.

Electronic system 100 may also include read only memory (ROM) and/or other static storage device 106 coupled to bus 101 that may store static information and instructions for processor 102. Data storage device 107 may be coupled to bus 101 to store information and instructions. Data storage device 107 such as a magnetic disk or optical disc and corresponding drive may be coupled to electronic system 100. ROM 106 and/or data storage device 107 may be flash memory. The example of FIG. 1 illustrates flash memory 190 as including control circuitry 195 and buffers 198 as being part of data storage device 107; however, other configurations may also be supported. Data storage device may also include storage media in addition to flash memory 190 (not shown in FIG. 1).

Electronic system 100 may also be coupled via bus 101 to display device 121, such as a cathode ray tube (CRT) or liquid crystal display (LCD), to display information to a user. Alphanumeric input device 122, including alphanumeric and other keys, may be coupled to bus 101 to communicate information and command selections to processor 102. Another type of user input device is cursor control 123, such as a mouse, a trackball, or cursor direction keys to communicate direction information and command selections to processor 102 and to control cursor movement on display 121. Electronic system 100 further may include network interface(s) 130 to provide access to a network, such as a local area network. Network interface(s) 130 may include, for example, a wireless network interface having antenna 155, which may represent one or more antenna(e). Antenna 155 may be a deployable antenna that is part of a removable card as described herein.

In one embodiment, network interface(s) 130 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

Co-pending U.S. Patent Application Publication No. US 2005/0086574 A1 describes an example context of writing data to the logical memory space, how the data is directly mapped without translation to the physical address space, and how the requirements of low-density mode force holes in the physical address space, and, because of the mapping, the same holes in the logical address space.

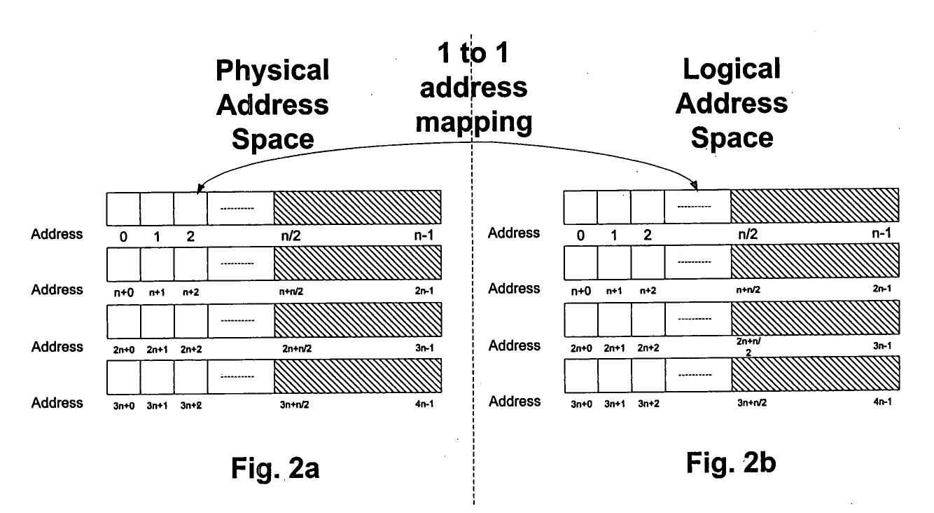

FIG. 2a is a conceptual illustration of a physical memory array in low-density mode corresponding to a logical memory having addressing holes. Flash memory device may combine one bit from the upper half of a codeword and one bit from the lower half of the codeword as the two bits to be stored in a multi-level flash cell. The resulting data in memory may correspond to FIG. 2a wherein alternating half codewords of memory are unused in low-density mode.

FIG. 2b is a conceptual illustration of a logical memory address in low-density mode having addressing holes. One of the consequences of using low-density mode is that the logical memory appears to have address gaps. One technique previously used is to require the application providing data to be written to the flash memory to store data in only the upper (or lower) half of a buffer. For example, only the lower byte may be used by prior art memory address translation circuitry, which may result in up to half of the memory addresses being unavailable. This may also result in increased addressing complexity when a user or application attempts to use a low-density mode of data storage.

Using the techniques described herein, data may be stored in a buffer without concern as to whether low-density mode is to be used. That is, the source of the data may not be required to store only a half codeword of data to a specific half (upper or lower) of the buffer. A full codeword of data may be stored in the buffer and, if low-density mode is to be used, memory address translation circuitry may translate the data as described below such that the data may be stored in low-density mode. This technique may simplify operations for the source of the data when the data is to be stored in low-density mode. One of the results is that the source of the data may not be required to work with the addressing consequences of low-density mode.

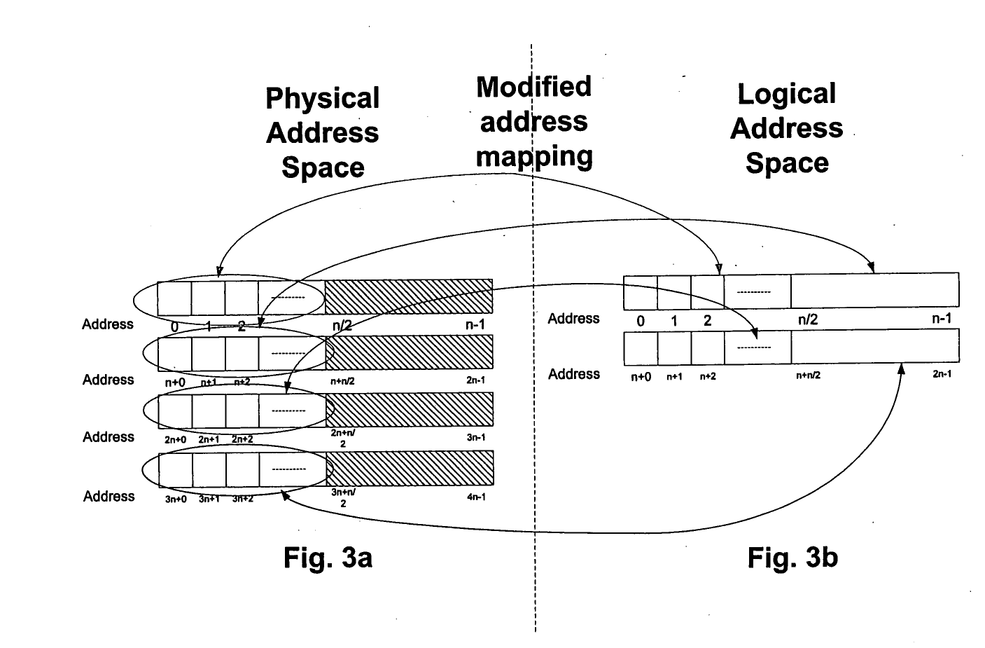

FIG. 3a is a conceptual illustration of a physical memory array in low-density mode corresponding to a logical memory not having addressing holes. FIG. 3b is a conceptual illustration of a logical memory array in low-density mode not having addressing holes. In one embodiment, the translation illustrated by FIGS. 3a and 3b may be performed by circuitry that is internal to a flash memory device so that the source of data is not required to compensate for the addressing consequences of low-density mode.

An application or other source of data may write a codeword of data to be stored in a flash memory device to a logical address as illustrated in FIG. 3b. In one embodiment when stored in low-density mode, the lower half codeword of data from the logical codeword (e.g., n/2 to n−1, n+n/2 to 2n−1) may be translated to an upper half codeword of a physical memory location in the flash memory array as illustrated in FIG. 3a.

In one embodiment, the lower half of the codeword in FIG. 3b may store a predetermined pattern, for example, all 1s or all 0s. This predetermined pattern aids in mapping the low-density mode states into selected high-density mode states, and allows the existing high-density mode circuits to effectively read and write low-density data. In one embodiment, the two states that are used to store a single bit in a multi-level cell are the most “distant” from each other. That is, 01 may be used to indicate a 0 in low-density mode and 11 may be used to indicate a 1 in low-density mode. Other mappings may also be used. The mappings may determine the predetermined pattern that is stored in the unused portion of a logical codeword.

By splitting a logical codeword between the upper (or lower) portion of two physical codewords using circuitry internal to the flash memory device, the original codeword may be written to a flash memory device in a low-density mode without requiring the source application to convert the codeword to a low-density format. Thus, memory addressing gaps and the associated overhead previously imposed on applications may be eliminated through transparent address translation performed on a codeword of data provided by the applications. The reverse process may be performed when data is read from the flash memory.

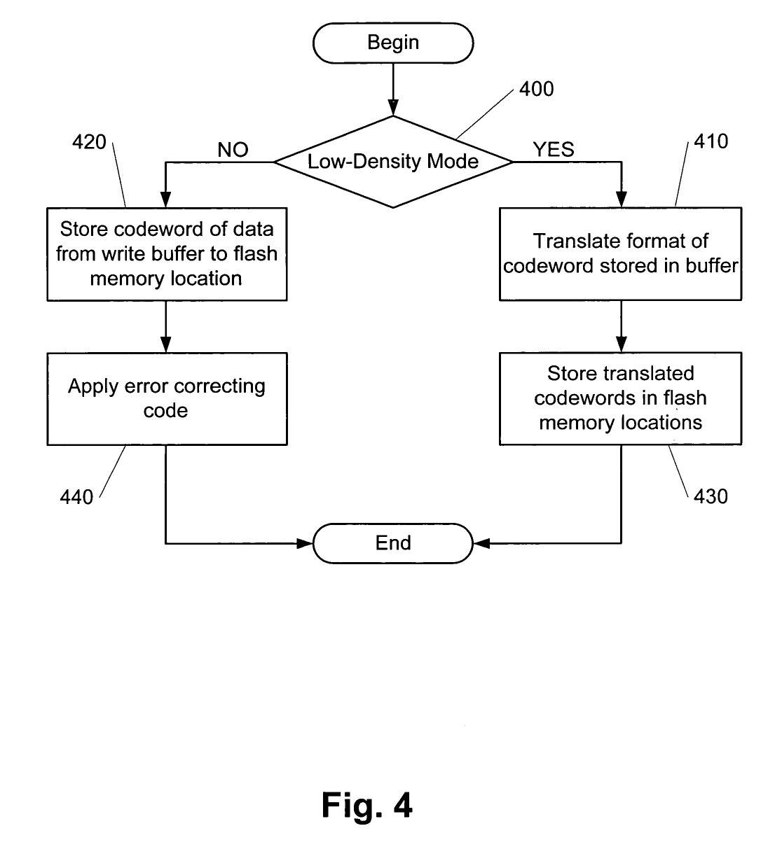

FIG. 4 is a flow diagram of one embodiment for writing a codeword of data to a flash memory device. In one embodiment, control circuit within a flash memory device may determine whether a low-density mode is to be used, 400. In alternate embodiments, memory address translation circuitry or other component may determine whether low-density mode is to be used.

If low-density mode is not to be used, 400, the codeword of data stored in a write buffer may be written to a memory location, 420, and (optionally) error correcting codes may be applied, 440, using any technique known in the art. Thus, if low-density mode is not to be used data stored in a write buffer may be written to the selected memory location with the full codeword of data stored in a codeword block of flash memory. For example, a two-byte codeword may be stored in adjacent bytes of flash memory.

If low-density mode is to be used, 400, a codeword stored in a buffer may be translated as described above, 410. The translated, low-density formatted data may then be stored in flash memory locations, 430.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
translating a sub-block of data from a first portion of a block of data to be written to a flash memory array to a second portion of the block of data to be written; and
filling a first portion of the block of data to be written with a pre-selected sequence of bits.

2. The method of claim 1 further comprising storing the block of data to be written comprising the sub-block of data in the second portion and the pre-selected sequence of bits in the first portion to a memory location in the flash memory.

3. The method of claim 1 wherein the translating is performed in response to a first condition and in response to a second condition a block of data including the sub-block is written to a second memory location in the flash memory.

4. The method of claim 3 wherein an error correcting code is applied to the block of data prior to being written to the second memory location.

5. The method of claim 1 wherein the translation and filling is performed by a control circuit of a flash memory device.

6. The method of claim 1 wherein the translation and filling is performed by memory address translation circuitry.

7. The method of claim 1 wherein storing of the translated data comprises writing data to flash memory cells using two of four or more available states.

8. A flash memory device to receive data and to store the data in a buffer, the flash memory device having a control circuit to retrieve a sub-block of data to be written to a flash memory location, wherein the sub-block of data corresponds to less than a block of data to be written to a flash memory array, translating the sub-block of data from a first portion of a block of data to an second portion of the block of data to be written, filling the first portion of the block of data to be written with a pre-selected sequence of bits, and store the block of data to be written comprising the sub-block of data in the second portion and the pre-selected sequence of bits in the first portion to a memory location in the flash memory array.

9. The apparatus of claim 8 wherein the translation is performed in response to a first condition and in response to a second condition a block of data including the sub-block is written to a second memory location in the flash memory.

10. The apparatus of claim 9 wherein an error correcting code is applied to the block of data prior to being written to the second memory location.

11. The apparatus of claim 8 wherein storing of the translated data comprises writing data to flash memory cells using two of four or more available states.

12. A system comprising:
one or more substantially omnidirectional antennae;
a processor to perform computational operations coupled with the one or more antennae;
a flash memory device coupled with the processor to receive data from the processor and to store the data in a buffer, the flash memory device having a control circuit to retrieve, from the buffer, a sub-block of the data to be written to a flash memory location, wherein the sub-block of data corresponds to less than a block of data to be written to the flash memory, translating the sub-block of data from a first portion of a block of data to an second portion of the block of data to be written, filling the first portion of the block of data to be written with a pre-selected sequence of bits, and store the block of data to be written comprising the sub-block of data in the second portion and the pre-selected sequence of bits in the first portion to a memory location in the flash memory.

13. The system of claim 12 wherein the translation is performed in response to a first condition and in response to a second condition a block of data including the sub-block is written to a second memory location in the flash memory.

14. The system of claim 13 wherein an error correcting code is applied to the block of data prior to being written to the second memory location.

15. The system of claim 12 wherein storing of the translated data comprises writing data to flash memory cells using two of four or more available states.

16. An apparatus comprising:
means for retrieving, from a data buffer, a sub-block of data to be written to a flash memory, wherein the sub-block of data corresponds to less than a block of data to be written to the flash memory;
means for translating the sub-block of data from a first portion of a block of data to a second portion of the block of data to be written;
means for filling a first portion of the block of data to be written with a pre-selected sequence of bits; and
means for storing the block of data to be written comprising the sub-block of data in the second portion and the pre-selected sequence of bits in the first portion to a memory location in the flash memory.

17. The apparatus of claim 16 wherein the translation is performed in response to a first condition and in response to a second condition a block of data including the sub-block is written to a second memory location in the flash memory.

18. The apparatus of claim 17 wherein an error correcting code is applied to the block of data prior to being written to the second memory location.

19. The apparatus of claim 17 wherein the translation and filling is performed by a control circuit of a flash memory device.
